(19) United States
(12) Patent Application Publication
(10) Pub. No.: US 2009/0135706 A1
(43) Pub. Date: May 28, 2009

(54) Optical recording medium, and optical recording method and optical recording apparatus thereof

(76) Inventors: Soh Noguchi, Kanagawa (JP); Tsutomu Sato, Kanagawa (JP); Tatsuya Tomura, Tokyo (JP); Yasunobu Ueno, Kanagawa (JP); Ikuo Shimizu, Tokyo (JP); Motoharu Kinugasa, Mie (JP); Hiroshi Toyoda, Mie (JP)

Correspondence Address: COOPER & DUNHAM, LLP, 30 Rockefeller Plaza, 20th Floor, NEW YORK, NY, 10112, US

(21) Appl. No.: 11/886,972

(22) PCT Filed: Mar. 17, 2006
(86) PCT No.: PCT/JP2006/305894

§ 371 Date: Oct. 17, 2008

(30) Foreign Application Priority Data
Mar. 25, 2005 (JP) 2005-088692
Mar. 25, 2005 (JP) 2005-088693

(51) Int. Cl. G11B 7/00; G11B 7/24; G11B 7/246

(52) U.S. Cl. 369/272.1; 428/64.4; 428/64.8; G9B/7.139; G9B/7.166; G9B/7

(57) ABSTRACT

The present invention provides an optical recording medium including a substrate and a recording layer on the substrate having a squarylium metal chelate compound with a central metal. The recording layer includes a mixture of squarylium metal chelate compounds having ligands of the same type as well as metals of two or more types as the central metal. It is preferable that the recording layer includes a squarylium metal chelate compound having a bivalent metal as its central metal and a squarylium metal chelate compound having a metal other than a bivalent metal as its central metal.

### TECHNICAL FIELD

The present invention relates to an optical recording medium of a large capacity, and particularly, to an optical recording medium with a recording layer including a squarylium metal chelate compound in which a recording; a reproducing, and an addition of information are possible by irradiating a light beam, and to an optical recording method and an optical recording apparatus in which the optical recording medium is used.

### BACKGROUND ART

At present, a development of write-once-read-many DVD medium as a large-capacity optical disc has been promoted. As an elemental technology for an improvement of recording capacity, a development of a recording material for making recording pits minute, an introduction of an image compression technique which is typified by MPEG 2, and a technological development related to shortening the wavelength of a semiconductor laser for reading a recording pit are necessary.

Regarding the technology to shorten the wavelength, only an AlGaInP semiconductor laser in a red wavelength region has been hitherto commercialized with 670-nm band for bar-code readers, and measuring instruments, but with the increasing density of an optical disc, the use of a red laser beam is spreading in an optical storage market.

Regarding a DVD drive, the wavelength of a semiconductor laser in a band of 630 nm to 690 nm is standardized as a light source. Moreover, a commercialized reproducing-only DVD-ROM drive has a wavelength of approximately 650 nm.

On the other hand, regarding the recording material, dyes such as cyanine dye, and phthalocyanine dye have been known for a CD-R (write-once-read-many compact disc), but such dyes cannot be used for DVD-R (write-once-read-many digital versatile disc) since there is no absorption edge in the optical absorption spectra of such dyes which corresponds to the short-wavelength region of the used red laser beam. Therefore, there is a demand for a medium capable of recording and reproducing at a wavelength of 630 nm to 690 nm, the most preferable wavelength for a write-once-read-many DVD medium.

In regard to such technological demand, until today various materials have been proposed for a recording layer such as polymethine dye (e.g. Patent Literature 1), salt-forming dye of a cyanine dye with an azo metal chelate dye (e.g. Patent Literature 2), azo dye (e.g. Patent Literatures 3 and 4), formazan dye (e.g. Patent Literature 5), tetraaza porphyrin dye (Patent Literature 6), dipyrromethene dye (e.g. Patent Literature 7), and styryl dye.

On the other hand, the applicants of the present patent application have focused on squarylium compounds or the metal chelate compounds thereof which have the maximum absorption wavelength at 550 nm to 650 nm as a media on which recording and reproducing at a wavelength of 630 nm to 690 nm can be performed and have proposed optical recording media including these components (e.g. Patent Literatures 8 to 14).

According to their research, an optical recording medium, and particularly an optical recording medium with less dependency on the recording wavelength may be achieved, where the optical recording media may be applied to a write-once-read-many DVD medium which uses a semiconductor laser having an oscillation wavelength in a shorter wavelength region compared to a conventional optical recording medium because of its optical characteristics.

In using a dye material as a recording material for the write-once-read-many DVD medium, it is possible to control the optical characteristics more precisely by mixing two or more types of dye materials and to provide a superior write-once-read-many DVD medium.

However, when two or more types of squarylium metal chelate compounds having different ligands are mixed and left in an organic solvent for a long period of time, a scrambling of chelate ligands take place to form the isomers. Generally in manufacturing an optical recording medium including an organic dye material used in the recording layer, materials scattered during the application of an organic dye material by means of a spin-coating method are in many cases recovered and reused for cost reduction. In such reuse, two or more types of squarylium metal chelate compounds having a different metal as a metal are mixed, and there has been a problem that a concentration determination of the dye becomes difficult due to the exchange of ligands when the respective ligands are different.

Patent Literature 1 Japanese Patent (JP-B) No. 3503679

Patent Literature 2 JP-B No. 3364231

Patent Literature 3 Japanese Patent Application Laid-Open (JP-A) No. 11-310728

Patent Literature 4 JP-A No. 2000-127625

Patent Literature 6 JP-A No. 2001-23235

Patent Literature 6 JP-A No. 2002-283721

Patent Literature 7 JP-A No. 10-226172

Patent Literature 8 International Publication No. WO 01/044233

Patent Literature 9 International Publication No. WO 01/044375

Patent Literature 10 JP-A No. 2001-322356

Patent Literature 11 JP-A No. 2002-370451

Patent Literature 12 JP-A No. 2002-370454

Patent Literature 13 JP-A No. 2004-42624

Patent Literature 14 International Publication No. WO 02/050190

### DISCLOSURE OF INVENTION

It is an object of the present invention to provide: an optical recording medium containing a recording layer formed with a mixture of multiple squarylium metal chelate compounds, which is stable even after a prolonged storage or repeated usage and enables a concentration determination of a squarylium metal chelate compound, where the optical recording medium has further improved light resistance and is applicable to a write-once-read-many DVD medium which enables a precise control of its optical properties compared to that formed with conventional squarylium compounds and aluminum chelate compounds thereof, an optical recording method and an optical recording apparatus which use thereof.

Means for solving the above-mentioned issues are as follow.

<1> An optical recording medium including a substrate and a recording layer having squarylium metal chelate compounds,

wherein the recording layer includes a mixture of squarylium metal chelate compounds having two or more different metals.

<2> The optical recording medium according to <1>,

wherein the recording layer includes a squarylium metal chelate compound having a bivalent metal as its metal and a squarylium metal chelate compound having a metal other than a bivalent metal as its metal.

<3> The optical recording medium according to any one of <1> to <2>, wherein the squarylium metal chelate compounds include the same ligand.

<4> The optical recording medium according to any of <1> to <3>, wherein the squarylium metal chelate compounds are represented by General Formula (I) below:

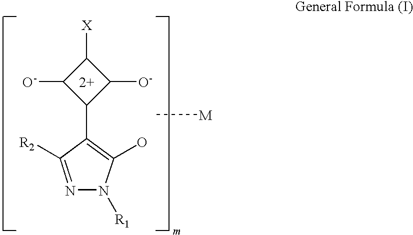

wherein, in General Formula (I), R₁ and R₂ are the same or different and represent a hydrogen atom, an aliphatic group which may have a substituent, an aralkyl group which may have a substituent, an aryl group which may have a substituent or a heterocyclic group which may have a substituent; M represents a metal atom which has a coordinating property; m represents an integer of two or three; X represents an aryl group which may have a substituent, a heterocyclic group which may have a substituent or [Z₁=CH—], in which Z₁ represents a heterocyclic group which may have a substituent.

<5> The optical recording medium according to <3>, wherein X in General Formula (I) is represented by General Formula (II) below:

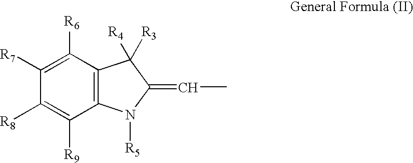

wherein, in General Formula (II), R₃ and R₄ are the same or different and represent an aliphatic group which may have a substituent or are taken together with an adjacent carbon atom to an alicyclic hydrocarbon ring which may have a substituent or a heterocyclic ring which may have a substituent; R₅ represents a hydrogen atom, an aliphatic group which may have a substituent, an aralkyl group which may have a substituent or an aryl group which may have a substituent; R₆ to R₉ may be the same or different and represent a hydrogen atom, a halogen atom, an aliphatic group which may have a substituent, an aralkyl group which may have a substituent, an aryl group which may have a substituent, a nitro group, a cyano group, or an alkoxyl group which may have a substituent; and two mutually adjacent functional groups among R₆ to R₉ may combine with two respective adjacent carbon atoms to form a ring which may have a substituent.

<6> The optical recording medium according to any one of <1> to <5>, wherein the central metal is a metal selected from aluminum, nickel, copper and zinc.

15<7> The optical recording medium according to any one of <2> to <6>, wherein the bivalent metal is at least any one metal selected from nickel, copper and zinc.

<8> The optical recording medium according to any one of <2> to <7>, wherein the squarylium metal chelate compound having a metal other than the bivalent metal as its central metal is a trivalent aluminum chelate compound.

<9> The optical recording medium according to any one of <1> to <8>, wherein the recording layer further includes at least one type of a metal chelate dye selected from an azo metal chelate dye, a formazan metal chelate dye and a dipyrromethene metal chelate dye.

<10> The optical recording medium according to <9>, wherein the metal of the metal chelate dye is at least one metal selected from nickel, copper, cobalt, manganese and vanadium oxide.

<11> The optical recording medium according to any one of <1> to <10>, wherein the recording layer as a monolayer has a refractive index n of 1.5≦n≦3.0 and an extinction coefficient k of 0.02≦k≦0.3 with respect to a light having a wavelength of the recording and reproducing wavelength ±5 nm.

<12> The optical recording medium according to any one of <1> to <11>, wherein the recording medium includes a reflective layer, and the reflective layer is any one of gold, silver, copper, aluminum and an alloy of these metals.

<13> The optical recording medium according to any one of <1> to <12>, wherein the optical recording medium has a track pitch on the substrate of 0.7 μm to 0.8 μm and a groove width of 0.18 μm to 0.40 μm.

<14> The optical recording medium according to any one of <1> to <13>, wherein the recording is possible at a recording wavelength of 600 nm to 720 nm.

<15> An optical recording method which performs a recording at a wavelength of 600 nm to 720 nm in the optical recording medium according to any one of <1> to <14>.

<16> An optical recording apparatus having a recording medium therein, wherein the optical recording apparatus performs recording and reproducing by irradiating a light to the recording medium; and

the recording medium is the optical recording medium according to any one of <1> to <14>.

### BRIEF DESCRIPTION OF DRAWINGS

FIG. 1A is a schematic cross-sectional diagram showing an example of a layer composition of an optical recording medium of the present invention;

FIG. 1B is a schematic cross-sectional diagram showing an example of the layer composition of an optical recording medium of the present invention;

FIG. 1C is a schematic cross-sectional diagram showing an example of the layer composition of an optical recording medium of the present invention;

FIG. 1D is a schematic cross-sectional diagram showing an example of the layer composition of an optical recording medium of the present invention;

FIG. 2A is a schematic cross-sectional diagram showing another example of the layer composition of an optical recording medium of the present invention;

FIG. 2B is a schematic cross-sectional diagram showing another example of the layer composition of an optical recording medium of the present invention;

FIG. 2C is a schematic cross-sectional diagram showing another example of the layer composition of an optical recording medium of the present invention;

FIG. 3A is a schematic cross-sectional diagram showing still another example of the layer composition of an optical recording medium of the present invention;

FIG. 3B is a schematic cross-sectional diagram showing yet another layer composition of an optical recording medium of the present invention;

FIG. 3C is a schematic cross-sectional diagram showing yet another layer composition of an optical recording medium of the present invention;

FIG. 4 is a liquid chromatography chart of a solution (immediately after dissolving) in which a squarylium metal chelate mixture in Example 1 is dissolved;

FIG. 5 is a liquid chromatography chart of a solution (immediately after dissolving) of a solution (after leaving for 14 days) in which the squarylium metal chelate mixture in Example 1 is dissolved;

FIG. 6 is a liquid chromatography chart of a solution (immediately after dissolving) in which a squarylium metal chelate mixture in Comparative Example 1 is dissolved; and

FIG. 7 is a liquid chromatography chart of a solution (after 14 days) in which the squarylium metal chelate mixture in Comparative Example 1 is dissolved

### BEST MODE FOR CARRYING OUT THE INVENTION

### (Optical Recording Medium)

An optical recording medium of the present invention has a substrate and a recording layer on the substrate which includes a squarylium metal chelate compound and it further has other layers according to requirements.

The recording layer includes squarylium metal chelate compounds having two or more different metals. This further improves the resistance compared to a conventional squarylium compound and an optical recording medium having a conventional squarylium compound and an aluminum chelate compound thereof and prevents light degradation of the recording layer in repeated recording and reproducing.

Moreover, it is preferable that the recording layer includes a squarylium metal chelate compound having a bivalent metal as its central metal and that a squarylium metal chelate compound having a metal other than a bivalent metal as its central metal.

Thus, the recording layer including squarylium metal chelate compounds having respectively the bivalent metal and the metal other than the bivalent metal as the central metal improves the resistance compared to a conventional squarylium compound and an optical recording medium having a conventional squarylium compound and an aluminum chelate compound thereof and prevents light degradation of the recording layer in repeated recording and reproducing.

Moreover, to satisfy the recording and reproducing performance of a write-once-read-many DVD medium such as recording sensitivity and the reflectivity, it is necessary to control precisely the optical characteristics such as absorption wavelength in a dye material forming the recording material. It is possible, for example, to control the optical characteristics by selecting a substituent of a dye material, but it is not necessarily sufficient. Even more precise control is possible by mixing squarylium metal chelate compounds of the present invention having a bivalent metal and a metal other than a bivalent metal respectively as its central metal.

Also, the squarylium metal chelate compounds having two or more different metals used for the recording layer of the present invention preferably have the same ligand, and more preferably have identical ligands. Thus, the recording layer of the present invention including the squarylium metal chelate compounds indicates no change involved in a scrambling of ligands after prolonged storage in a solution and repeated reuse because of no formation of isomer. Therefore, it is possible, for example, to perform a stable concentration determination of the squarylium metal chelate compound and to manufacture efficiently a high-quality optical recording medium.

The optical recording medium of the present invention is applicable to a so-called write-once-read-many DVD disc system; therefore, the optical recording medium preferably has a recording layer which enables optical recording and reproducing by a laser beam having a recording and reproducing wavelength of 600 nm to 720 nm. Because of the optical characteristics with respect to this wavelength range, it is preferable to use as the recording layer a mixture composed of squarylium metal chelate compounds represented by General Formula (I) below:

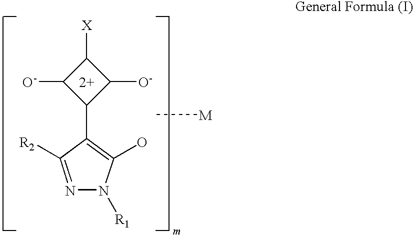

where, in General Formula (I), R₁ and R₂ are the same or different and represent a hydrogen atom, an aliphatic group which may have a substituent, an aralkyl group which may have a substituent, an aryl group which may have a substituent or a heterocyclic group which may have a substituent; M represents a metal atom which has a coordinating property; m represents an integer of two or three; X represents an aryl group which may have a substituent, a heterocyclic group which may have a substituent or [Z₁=CH—], in which Z₁ represents a heterocyclic group which may have a substituent.

Examples of the metal atom M in General Formula (I) above include a metal selected from aluminum, iron, cobalt, nickel, manganese, zinc, beryllium, magnesium and calcium. Among them, aluminum, nickel, copper, and zinc are preferable with respect to optical characteristics and light resistance. Here, each ligand coordinated with the central metal is identical.

Preferably, the metal atom M as a bivalent metal atom is at least any one of a metal selected from nickel, copper and zinc.

Examples of a metal other than the bivalent metal include compounds such as aluminum, iron, chromium, cobalt, manganese, iridium and vanadium, and aluminum is preferable particularly with respect to optical characteristics.

A squarylium metal chelate compound having such metal as the central metal is preferably a trivalent aluminum chelate compound. A trivalent aluminum chelate compound having a structure represented by General Formula (III) below is more preferable:

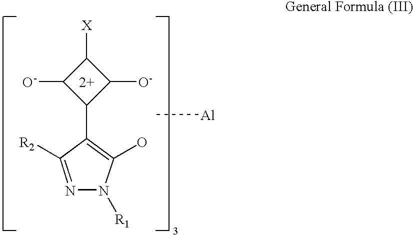

where, in General Formula (III), R₁, R₂ and X are equivalent to those respectively defined above.

X in General Formula (I) is preferably a group represented by General Formula (II) below:

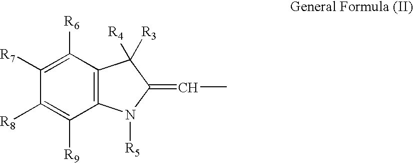

where, in General Formula (II), R₃ and R₄ are the same or different and represent an aliphatic group which may have a substituent or are taken together with an adjacent carbon atom to form an alicyclic hydrocarbon ring or a heterocyclic ring; R₅ represents a hydrogen atom, an aliphatic group which may have a substituent, an aralkyl group which may have a substituent or an aryl group which may have a substituent; R₆ to R₉ may be the same or different and represent a hydrogen atom, a halogen atom, an aliphatic group which may have a substituent, an aralkyl group which may have a substituent, an aryl group which may have a substituent, a nitro group, a cyano group, or an alkoxyl group which may have a substituent; and two mutually adjacent functional groups among R₆ to R₉ may combine with two respective adjacent carbon atoms to form a ring which may have a substituent.

Further, details of each group in General Formula (I) above is described below.

The aliphatic group includes an alkyl group and an alkenyl group. Moreover, the alkyl group and the alkenyl group can be in the form of a linear chain, a branched chain or a ring. The aliphatic group preferably has a carbon number of 1 to 6 as a linear chain or a branched chain, and 3 to 8 as a ring.

Examples of the aliphatic group include a methyl group, an ethyl group, a propyl group, an isopropyl group, a butyl group, an isobutyl group, a sec-butyl group, a tert-butyl group, a pentyl group, an isopentyl group, a 1-methylbutyl group, a 2-methylbutyl group, a tert-pentyl group, a hexyl group, a cyclopropyl group, a cyclobutyl group, a cyclopentyl group, a cyclohexyl group, a cycloheptyl group, a cyclooctyl group, a vinyl group, an allyl group, a 1-propenyl group, a methacryl group, a crotyl group, a 1-butenyl group, a 3-butenyl group, a 2-pentenyl group, a 4-pentenyl group, a 2-hexenyl group, a 5-hexenyl group, a 2-heptenyl group and a 2-octenyl group.

The alkyl portion in the alkoxyl group can be an alkyl group in the form of a linear chain, branched chain or a ring. The alkyl group preferably has a carbon number of 1 to 6 when the alkyl group is a linear chain or a branched chain, and 3 to 8 when it is a ring. Examples of the alkyl group include a methyl group, an ethyl group, a propyl group, an isopropyl group, a butyl group, an isobutyl group, a sec-butyl group, a tert-butyl group, a pentyl group, an isopentyl group, a neopentyl group, a hexyl group, a heptyl group, an octyl group, a nonyl group, a decyl group, a cyclopropyl group, a cyclobutyl group, a cyclopentyl group, a cyclohexyl group a cycloheptyl group and a cyclooctyl group.

The aralkyl group preferably has a carbon number of 7 to 15, and examples include a benzyl group, a phenethyl group, a phenylpropyl group and a naphthyl group.

The aryl group preferably has a carbon number of 6 to 18, and examples include a phenyl group, a naphthyl group, an anthryl group and an azulenyl group.

Examples of the halogen atom include a chlorine atom, a bromine atom, a fluorine atom and an iodine atom.

Moreover, examples of the substituent in the aralkyl group, an aryl group, an alkoxy group, an aromatic ring, a heterocyclic group or a ring formed by adjacent functional groups among R₆ to R₅ with their respective two adjacent carbon atoms include a hydroxyl group, a carboxyl group, a halogen atom, an alkyl group, an alkoxy group, a nitro group and an amino group which may have a substituent.

Examples of the halogen atom, the alkyl group and the alkoxy group are equivalent to those mentioned above. There may be one or more of these substituents in a molecule.

Examples of the substituent of the aliphatic group and the alkoxyl group include a hydroxyl group, a carboxyl group, a halogen atom and an alkoxy group. Examples of the halogen atom and alkoxy group are equivalent to those mentioned above. There may be one or more of these substitutes in a molecule.

Examples of the substituent of the amino group include one to two alkyl groups which may be the same or different, and examples of the alkyl group in this case are equivalent to those mentioned above.

The ring which is formed by combining of two mutually adjacent groups among R₆ to R₉ with two respective adjacent carbon atoms includes, other than an aromatic ring having a carbon number of 6 to 14 such as benzene ring, an aliphatic ring having a carbon number of 3 to 10 such as cyclohexane ring.

In General Formulae (I) and (II), examples of the heterocyclic ring in the heterocyclic group, and the heterocyclic ring formed by R₃ and R₄ taken together with an adjacent carbon atom include: a five-membered or six-membered monocyclic aromatic or aliphatic heterocyclic ring which includes at least one atom selected from nitrogen atom, oxygen atom, and sulfur atom; and a bicyclic or tricyclic fused aromatic or aliphatic heterocyclic ring which includes a 3- to 8-membered fused ring and at least one atom selected from nitrogen atom, oxygen atom and sulfur atom.

Specific examples of the heterocyclic ring include a pyridine ring, a pirazine ring, a pyrimidine ring, a pyridazine ring, a quinoline ring, an isoquinoline ring, a phthalazine ring, a quinazoline ring, a quinoxaline ring, a naphthyridine ring, a cinnoline ring, a pyrrole ring, a pyrazole ring, an imidazole ring, a triazol ring, a tetrazole ring, a thiophene ring, a furan ring, a thiazole ring, a oxazole ring, a indole ring, isoindole ring, indazole ring, a benzimidazole ring, a benzotriazole ring, a benzothiazole ring, a benzoxazole ring, a purine ring, a carbazole ring, a pyrrolidine ring, a piperidine ring, a piperazine ring, a morpholine ring, a thiomorpholine ring, a homopiperidine ring, a homopiperazine ring, a tetrahydropyridine ring, a tetrahydroquinoline ring, a tetrahydroisoquinoline ring, a tetrahydrofuran ring, a tetrahydropyran ring, a dihydrobenzofuran ring and a tetrahydrocarbazole ring.

Examples of the heterocyclic group of Z₁ in [Z₁=CH—] above include indoline-2-ylidene, benzo[e]indoline-2-ylidene, 2-benzothiazolinylidene, naphtho[2,1-d]thiazole-(3H)-ylidene, naphtho[1,2-d]thiazole-2(1H)-ylidene, 1,4-dihydroquinoline-4-ylidene, 1,2-dihydroquinoline-2-ylidene, 2,3-dihydro-1H-imidazo[4,5-d]quinoxaline-2-ylidene and 2-benzoselenazolinilidene.

Moreover, preferable examples of an alicyclic hydrocarbon ring which is formed by R₃ and R₄ taken together with an adjacent carbon atom include a ring having a carbon number of 3 to 8, and the ring may be saturated or unsaturated. Examples thereof include a cyclopropane ring, a cyclobutane ring, a cyclopentane ring, a cyclohexane ring, a cycloheptane ring, a cyclooctane ring, a cyclopentene ring, 1,3-cyclopentadiene ring, a cyclohexene ring and a cyclohexadiene ring.

The compound represented by General Formula (I) above in the present invention can be manufactured according to a heretofore known method such as one described in International Publication No. WO 02/50190. The following describes a manufacturing method thereof.

Here, the compound represented by General Formula (I) is also referred to as Compound (1). Moreover, the compounds represented by the other formulae may also be referred to in the similar manner.

As shown in Reaction Scheme (IV) below, Compound (1) is obtained by reacting Compound (3) and a material which imparts a metal ion (M^{m+}).

For example, Compound (1) is manufactured by reacting one part by mole of Compound (3) with (0.5 to 2)/m parts by mole of M^{m+} (material which imparts metal ions) in a solvent for 1 hour to 15 hours at a room temperature to 120° C., optionally in the presence of 0.5 to two parts by mole of acetic acid:

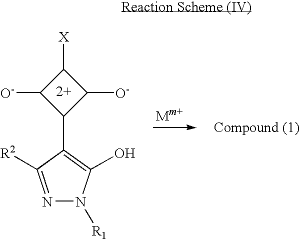

where, in Reaction Scheme (IV), R₁, R₂, M, m and X are equivalent to those mentioned above for General Formula (I), a group expressed in General Formula (II) is includes.

Examples of the material which imparts M^{m+} in the above reaction include aluminum tris(acetylacetonate), aluminum tris(ethylacetoacetate), aluminum isoproxide, aluminum sec-butoxide, aluminum ethoxide, aluminum chloride, nickel acetate, nickel acetylacetonate, copper chloride, copper acetate, copper acetylacetonate, zinc chloride, zinc acetate, zinc acetylacetonate, beryllium sulfate and magnesium acetylacetonate.

Examples of the reaction solvent include: a halogen solvent such as chloroform and dichloromethane; an aromatic solvent such as toluene and xylene, an ether solvent such as tetrahydrofuran, methyl tert-butyl ether; an ester solvent such as ethyl acetate; an alcohol solvent such as methanol, ethanol and isopropyl alcohol; and a mixture of these solvents.

Tables 1, 2 and 3 show specific examples of a portion corresponding to a ligand excluding the central metal of the squarylium metal chelate compound obtained by the above reaction and represented by General Formula (I), i.e. a portion corresponding to Compound (3) in Reaction Scheme (IV).

In examples, a compound number in Tables 1 to 3 indicates a compound number of a ligand, and hereinafter a metal chelate compound having this as its ligand is represented by the compound number followed by its central atom. For example, an aluminum chelate compound (complex) derived from a squarylium compound A-1 is represented as A-1-A1. Moreover, compounds in the tables are only examples, and the squarylium metal chelate compounds of the present invention are not restricted to the compounds in the table.

TABLE 1

| Ligand of metal | |
|---|---|
| chelate compound | Structural formula of squarylium compound |
| A-1 | 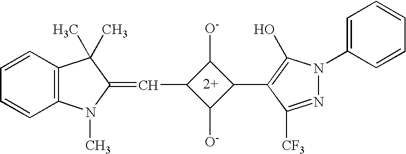 |
| A-2 | 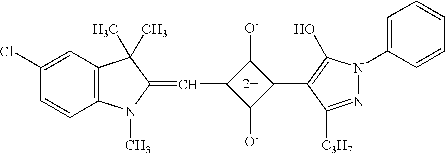 |
| A-3 | 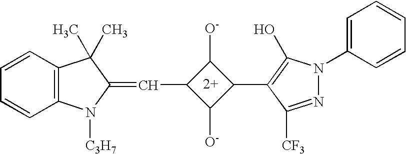 |
| A-4 | 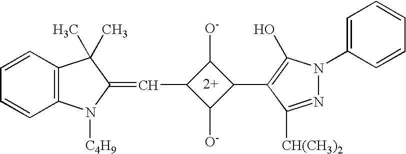 |
| A-5 | 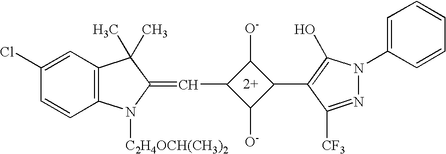 |
| A-6 | 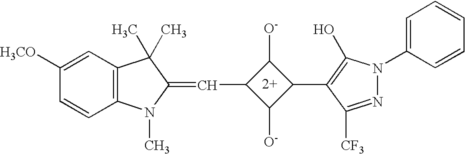 |
| A-7 | 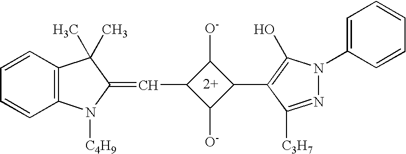 |

TABLE 2

| Ligand of metal | |
|---|---|
| chelate compound | Structural formula of squarylium compound |
| A-8 | 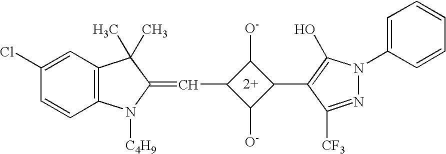 |
| A-9 | 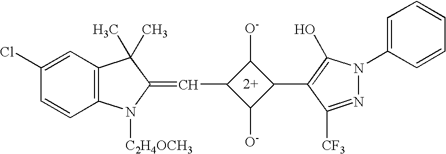 |
| A-10 | 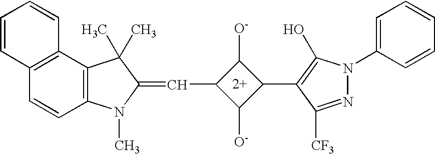 |
| A-11 | 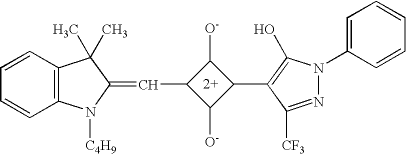 |
| A-12 | 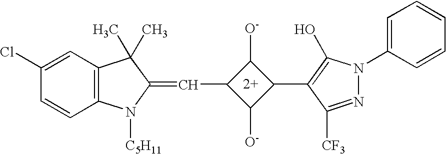 |
| A-13 | 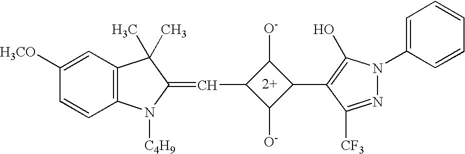 |
| A-14 | 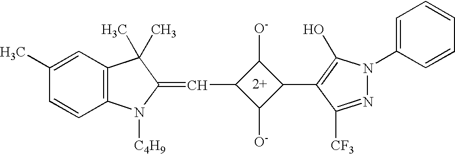 |

TABLE 3

| Code of metal | |
|---|---|
| chelate compound | Structural formula of squarylium compound |
| A-15 | 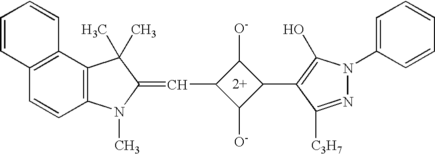 |
| A-16 | 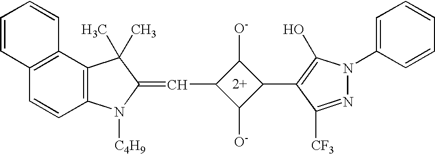 |

It is possible to include, in addition to the squarylium metal chelate compounds, other dye materials in the recording layer of the optical recording medium of the present invention.

Examples of such dye materials include an azo dye, a formazan dye, a dipyrromethene dye, a polymethine dye and an azaanulene dye. Among these, various metal chelate dye materials are preferable from a point of view of improving further the light resistance, and an azo metal chelate dye, a formazan metal chelate dye and a dipyrromethene metal chelate dye are particularly preferable.

Here, a structure represented by General Formula (V) below is preferable as an azo dye in an azo metal chelate dye.

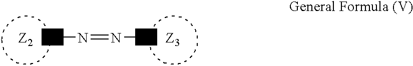

where, in General Formula (V), each of Z₂ and Z₃ indicate moieties to form an azo compound, representing an aromatic ring which may have a substituent, a pyridine residue, a pyrimidine residue, a pyrazine residue, a pyridazine residue, a triazine residue, a imidazole residue, a thiazole residue, a triazole residue, a pyrazole residue, a isothiazole residue and a benzothiazole residue.

Then, an azo compound is formed by the combination of the moieties to form an azo compound (Z₂ and Z₃) between the azo bond, and metal chelate compounds of such azo compounds are preferable. The metal of the metal chelate compound is a bivalent metal atom.

Moreover, a formazan moiety in the formazan metal chelate dye is a structure represented by General Formula (VI) below:

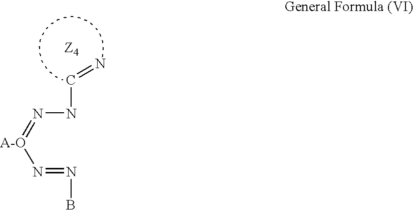

where, in General Formula (VI), Z₄ represents a residue which forms a polyheterocycle together with a carbon atom and a nitrogen atom which Z₄ is bonded with; A represents an alkyl group, an aralkyl group, an aryl group and a cyclohexyl group; and B represents an aryl group.

Specific examples of the alkyl group, the aralkyl group and the aryl group are similar to the examples listed above.

Examples of the residue which forms the polyheterocycle in the above formula include a pyridazine ring, a pyrimidine ring, a pyrazine ring and a triazine ring. Also, this heterocycle may have a substituent such as alkyl group, alkoxyl group, alkylthio group, substituted amino group, aryl group, aryloxy group and anilino group and carbonyl group. Moreover, A may have a substituent such as alkyl group, alkoxy group, halogen atom, carbonyl group, carboxyl group and ester of a carboxyl group, a nitrile group and a nitro group. Furthermore, B may have a substituent such as alkyl group, alkoxyl group, halogen atom, carboxyl group and ester of a carboxyl group, a nitrile group and a nitro group. The metal of the metal chelate compound is a bivalent metal atom.

Specific examples of the alkyl group, the alkoxyl group, the substituted amino group, the aryl group and the halogen atom are similar to the examples listed above. Also, the alkylthio group is a group in which an alkyl group and sulfur are bonded, and examples of the alkyl group are similar to those listed above. The aryloxy group is a group in which an aryl group and oxygen are bonded, and examples of the aryloxy group are similar to those listed above.

Moreover, a dipyrromethene moiety in the dipyrromethene metal chelate dye is a structure represented by General Formula (VII) below:

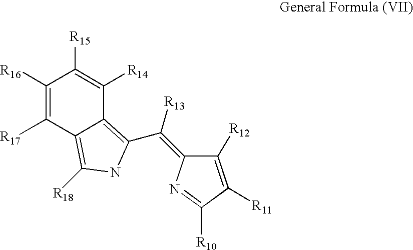

where, in General Formula (VII), each of R₁₀ to R₁₈ represents independently a hydrogen atom, a halogen atom, an alkyl group which may have a substituent, an alkoxyl group which may have a substituent, an alkenyl group which may have a substituent, an acyl group, a carboxyl group or an ester thereof, an aralkyl group, an aryl group and a heterocycle.

Specific examples of the halogen atom, the alkyl group, the alkoxyl group, the alkenyl group, the aralkyl group and the aryl group are similar to those listed above. Also, specific examples of the acyl group include an acetyl group, a propionyl group, a butyryl group and a benzoyl group.

When the dipyrromethene forms a metal chelate compound, the metal is a bivalent metal atom.

When the azo compound, the formazan compound and the dipyrromethene compound form a metal chelate compound, examples of the bivalent metal atom include transition metals such as nickel, copper, cobalt, manganese, vanadium oxide, zinc, iron, chromium and aluminum. Among these, nickel, copper, cobalt, manganese, and vanadium oxide are particularly preferable in view of the requirements of manufacturing and disc properties.

Specifically, with respect to a light in a wavelength region of recording and reproducing wavelength ±5 nm of the optical recording medium such as write-once-read-many optical recording medium, a single recording layer preferably has a refractive index n in a range of 1.5 to 3.0, i.e. 1.5≦n≦3.0, and an extinction coefficient k in a range of 0.02 to 0.3, i.e. 0.02≦k≦0.3.

The refractive index n of 1.5 or greater is preferable for sufficient optical change and improved recording modulation, and n of 3.0 or less is preferable for suppressed wavelength dependence and reduced reproducing errors even in the recording and reproducing wavelength region.

In addition, the extinction coefficient k of 0.02 or greater is preferable for favorable recording sensitivity, and k of 0.3 or less is preferable since the reflectivity of 50% or greater can be easily obtained. Furthermore, the refractive index n is enhanced by a larger absorption coefficient; therefore it is preferable that log thereof is five or larger, where E is a molar absorption coefficient.

Furthermore, in terms of light resistance, the recording layer preferably has a reproducing stability for one milling or more reproducing and light fastness such that there is no discoloration after leaving indoor. It is possible to facilitate the light resistance to meet such requirements by mixing a bivalent metal complex of a squarylium compound with other metal chelate dyes.

The substrate generally has a guide groove with a depth of 1000 Å to 2500 Å. The track pitch generally has a width of 0.7 μm to 1.0 μm, but for an application with larger capacity, the track pitch preferably has a width of 0.7 μm to 0.8 μm. The groove width in terms of half bandwidth is preferably 0.18 μm to 0.40 μm. The groove width of 0.18 μm or more is preferable since sufficient tracking error signal strength can be achieved. Moreover, the groove width of 0.40 or less is preferable since the transverse spread of a recording portion may be suppressed in recording.

Next, a structure of the optical recording medium of the present invention is described.

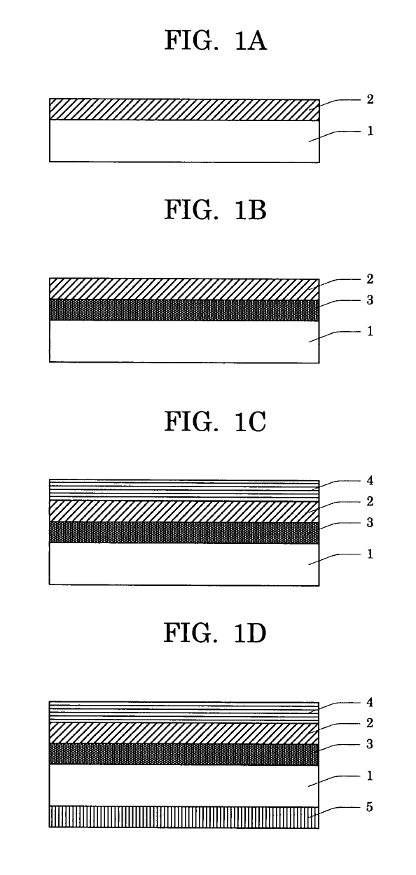

FIGS. 1A to 1D are schematic cross-sectional diagrams showing examples of a layer composition applicable to the optical recording medium of the present invention. These are examples of a write-once-read-many optical disc.

As shown in FIG. 1A, the layer composition has a structure including a recording layer 2 formed on a substrate 1. As shown in FIG. 1B, the layer composition is further provided on the substrate 1 with a recording layer 2 through an undercoat layer 3 according to requirements. As shown in FIG. 1C, the layer composition is further provided with a protective layer 4 according to requirements. As shown in FIG. 1D, the layer composition is provided on an outer surface of the substrate 1 in FIG. 1C with a hard coat layer 5 according to requirements.

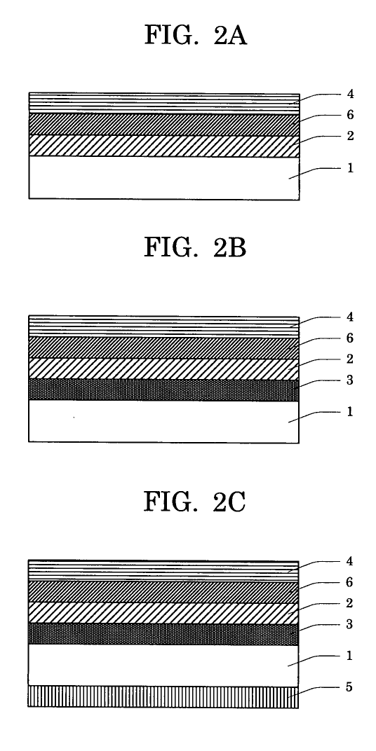

FIGS. 2A to 2C are schematic cross-sectional diagrams showing examples of a layer composition of another configuration applicable to the optical recording medium of the present invention. These are examples of a CD-R medium.

As shown in FIGS. 2A to 2C, the layer composition has a structure including a metallic reflective layer 6 provided on the recording layer 2 of the layer composition in FIGS. 1A to 1D. For example, FIG. 1C corresponds to FIG. 2B, FIG. 1D corresponds to FIG. 2C, and FIG. 2A is a structure in which the metallic reflective layer 6 is provided on a structure in which the protective layer 4 is provided in FIG. 1A.

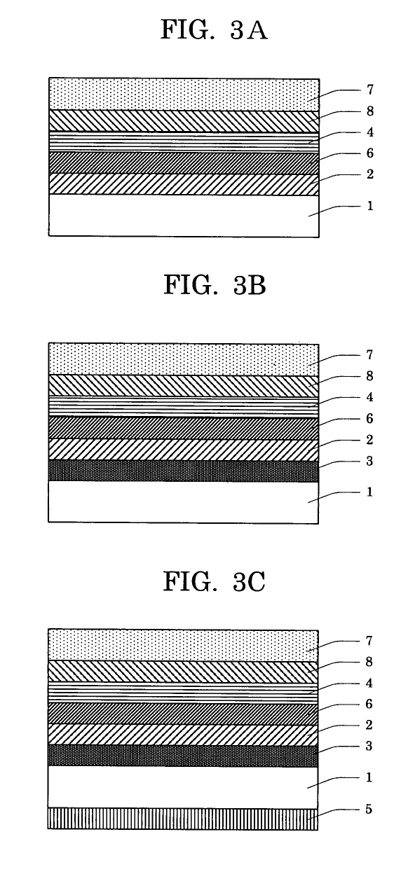

FIGS. 3H to 3J are schematic cross-sectional diagrams showing examples of a layer composition of yet another configuration applicable to the optical recording medium of the present invention. These are examples of a DVD medium.

As shown in FIGS. 3A to 3C, the layer composition has a structure including an adhesive layer 8 and a protective substrate 7 provided on the protective layer 4 of the layer compositions in FIGS. 2A to 2C. For example, FIG. 2A corresponds to FIG. 3A, FIG. 2B corresponds to FIG. 3B, and FIG. 2C corresponds to FIG. 3C.

Further, when the optical recording medium of the present invention is used as a write-once-read-many DVD medium, the basic structure of the optical recording medium has a structure in which a first substrate and a second substrate are laminated via a recording layer with an adhesive. In this case, the recording layer may be formed as a single-layer structure of an organic dye or a multi-layer structure in which a metallic reflective layer is laminated on the organic dye layer as a recording layer for improved reflectivity. The layer composition may be such that an undercoat layer or a protective layer is interposed between the recording layer and the substrate, or the structure may be such that the recording layer, the substrate, and the undercoat layer or the protective layer are laminated for improved performance. The most common structure includes a first substrate, an organic dye layer, a metallic reflective layer, a protective layer, an adhesive layer and a second substrate in this order.

The substrate, the recording layer, the undercoat layer, the metallic reflective layer, the protective layer, the adhesive layer, the hard coat layer on the surface of the substrate and the protective substrate which form the optical recording medium of the present invention are described in more detail.

### <Substrate>

As a property requirement of the substrate, the substrate must be transparent with respect to an applied laser beam when a recording and reproducing is performed from the side of the substrate. The substrate is not required to be transparent when the recording and reproducing is performed from the side of the recording layer. Therefore, when the two substrates are sandwiching the other layers in the present invention, the transparency of one substrate, e.g. first substrate, is not required as long as the other substrate, i.e. second substrate, is transparent.

Examples of a substrate material include: plastics such as polyester, acrylic resin, polyamide, polycarbonate resin, polyolefin resin, phenolic resin, epoxy resin and polyimide; glass, ceramics and metals.

Here, a guide groove and a guide pit for tracking, and further a preformat of an address signal may be formed on the surface of a substrate when only one substrate is used and on the surface of a first substrate when two substrates are used for the outermost surfaces of the medium.

### <Recording Layer>

The recording layer is a layer in which information can be recorded by means of some optical change caused by an irradiation of a laser beam, and it is necessary that the recording layer includes at least two or more types of squarylium metal chelate compounds having the same ligand and different central metals used in the present invention. In other words, regarding the formation of the recording layer, a plurality of squarylium metal chelate compounds having the same ligand used in the present invention are used in combination.

Furthermore, although the squarylium metal chelate compounds used in the present invention are used as dyes, the recording layer may be structured by mixing or laminating other organic dyes for the purpose of improving the optical characteristics, recording sensitivity and signal characteristics.

Examples of the organic dyes include: a metal chelate compound of an azo dye, a formazan dye and a dipyrromethene dye; a polymethine dye, a naphthalocyanine dye, a croconium dye, a pyrylium dye, a naphthoquinone dye, an anthraquinone (indanthrene) dye, a xanthene dye, a triphenylmethane dye, an azulene dye, a tetrahydrocholine dye, a phenanthrene dye and a triphenothiazine dye; and a metal chelate compound of them. These dyes can be used alone or in combination of two or more. The metal chelate compound is particularly preferable from a point of further improving the light resistance.

Among the dyes, metals and metallic compounds such as In, Te, Bi, Se, Sb, Ge, Sn, Al, Be, TeO₂, SnO, As and Cd can be used in the form of a dispersion mixture or a laminated layer.

Furthermore, the dye may be included by dispersion mixing with a polymer material such as ionomer resin, polyamide resin, vinyl resin, natural polymer, silicone, liquid rubber and a silane coupling agent, or a stabilizer such as transition metal complex, a dispersing agent, a flame retarder, a lubricant, an antistatic agent, a surfactant and a plasticizer can be used together for the purpose of improving the properties.

The recording layer can be formed by a common method such as vapor deposition, sputtering, CVD and solution coating. In a case of using a coating method, the organic dyes mentioned above including the squarylium metal chelate compounds is dissolved in an organic solvent and coated by a commonly used coating method such as spraying method, roller-coating method, dip-coating method and spin-coating method.

Examples of the organic solvent include alcohols such as methanol, ethanol, and isopropanol, ketones such as acetone, methyl ethyl ketone, and cyclohexanone, amides such as N,N-dimethylformamide and N,N-dimethylacetoamide, sulfoxides such as dimethylsulfoxide, ethers such as tetrahydrofuran, dioxane, diethylether and ethylene glycol monomethyl ether, esters such as methyl acetate and ethyl acetate, aliphatic halogenated hydrocarbons such as chloroform, methylene chloride, dichloroethane, carbon tetrachloride and trichloroethane, aromatic compounds such as benzene, xylene, monochlorobenzene and dichlorobenzene, cellosolves such as methoxyethanol and ethoxyethanol, hydrocarbons such as hexane, pentane, cyclohexane and methylcyclohexane, and fluorinated alcohols such as 2,2,3,3-tetrafluoropropanol.

The recording layer preferably has a thickness of 100 Å to 100,000 Å (10 μm), and more preferably and suitably 200 Å to 2000 Å.

### <Undercoat Layer>

The undercoat layer is used for the purpose of (a) improving the adhesion, (b) preventing the penetration of water or gas, (c) improving the storage stability of the recording layer, (d) improving the reflectivity, (e) protecting the substrate and the recording layer from the solvent, and (f) forming the guide groove, the guide pit and the preformat.

For the purpose (a), a polymer material of various polymer substances such as ionomer resin, polyamide resin, vinyl resin, natural resin, natural polymer, silicone, liquid rubber and silane coupling agent can be used. Moreover, for the purposes (b) and (c), in addition to the polymer materials mentioned above, inorganic compounds such as SiO₂, MgF₂, SiO, TiO₂, ZnO, TiN and SiN, and furthermore, metals or semimetals such as Zn, Cu, Ni, Cr, Ge, Se, Au, Ag and Al can be used. Furthermore, for the purpose (d), metals such as Al and Ag, and organic thin films having metallic luster such as methine dye and xanthene dye can be used; for the purposes (e) and (i), an ultraviolet-curing resin, a thermosetting resin and a thermoplastic resin can be used.

The undercoat layer preferably has a thickness of 0.01 μm to 30 μm, and more preferably 0.05 μm to 10 μm.

### <Metallic Reflective Layer>

As a material of the metallic reflective layer, an elemental, corrosion-inhibiting metal or semimetal for which a high reflectivity can be achieved is used. Specific examples thereof include Au, Ag, Cr, Ni, Al, Fe, Sn and Cu. Among these, Au, Ag, Al, and Cu are the most preferable in terms of reflectivity and productivity, and these metals and semimetals can be used alone or as an alloy of two or more.

As a film formation method of the metallic reflective layer, methods such as chemical deposition and sputtering are used. The metallic reflective layer preferably has a thickness of 50 Å to 5000 Å, and more preferable 100 Å to 3000 Å.

### <Protective Layer and Hard Coat Layer on Substrate Surface>

The protective layer or the hard coat layer on the substrate surface is used for the purposes of (a) protecting the recording layer (reflection absorption layer) from scratches, dust and stains, (b) improving the storage stability of the recording layer (reflection absorption layer), and (c) improving the reflectivity.

For these purposes, the materials listed for the undercoat layer can be used. In addition, materials such as SiO and SiO₂ can be used as an inorganic material. Furthermore, examples of an organic material include thermosoftening resins, hot-melt resins and ultraviolet-curing resins such as polymethyl acrylate, polycarbonate, epoxy resin, polystyrene, polyester resin, vinyl resin, cellulose, aliphatic hydrocarbon resin, aromatic hydrocarbon resin, natural rubber, styrene butadiene resin, chloroprene rubber, wax, alkyd resin, drying oil and rosin. Among these, an ultraviolet-curing resin is the most preferable example for the protective layer or the hard coat layer on the substrate surface for its excellent productivity.

The protective layer or the hard coat layer on the substrate surface has a thickness of preferably 0.01 μm to 30 μm, and more preferably 0.05 μm to 10 μm.

In the present invention, similarly to the case of the recording layer, the undercoat layer, the protective layer and the hard coat layer on the substrate surface may include additives such as stabilizer, dispersing agent, flame retardant, lubricant, antistatic agent, surfactant and plasticizer.

### <Protective Substrate>

The protective substrate must be transparent with respect to an applied laser beam when the laser beam is irradiated from the side of the protective substrate whereas the transparency is irrelevant when it is used solely as a protective plate.

Materials which can be used for the protective substrate are exactly the same as those for the substrate mentioned above, and those include plastics such as polyester, acrylic resin, polyamide, polycarbonate resin, polyolefin resin, phenolic resin, epoxy resin and polyimide; glass, ceramics; and metals.

### <Adhesive Layer>

The adhesive layer is a layer which is formed with a material that can bond two optical recording media and protective substrates and does not hinder the properties required for the optical recording media. The material is not particularly restricted, but the adhesive layer is preferably formed with an ultraviolet-curing or hot-melt adhesive in consideration of productivity.

Regarding the optical recording medium of the present invention, standardizing the ligands included in multiple squarylium metal chelate compounds included in the recording layer thereof and used as a mixture may be able to prevent the alteration of ligands of the squarylium metal chelate compounds. Accordingly the mixture solution of the squarylium metal chelate compounds can maintain its long-term storage stability and stability after repeated reuse, and the concentration determination of the squarylium metal chelate compounds becomes possible. When the recording layer is formed by using a mixture of this plurality of squarylium metal chelate compounds, it is possible to provide an optical recording medium which has a favorable light resistance and is applicable to a write-once-read-many DVD disc system.

Moreover, the inclusion of a squarylium metal chelate compound having a bivalent metal as its central metal and a squarylium metal chelate compound having a metal other than a bivalent metal as its central metal preferably in the recording layer of the optical recording medium of the present invention allows a precise control of the optical characteristics, renders superior optical characteristics without recording wavelength dependency, improves the light resistance and prevent the light-induced degradation of the recording layer caused by the light irradiation for repeated recording and reproducing. Accordingly, the optical recording medium of the present invention renders superior light resistance and optical characteristics compared to, for example, a conventional optical recording medium including a squarylium compound and aluminum chelate compound thereof are used.

Therefore, the optical recording medium of the present invention can be applied to, for example, a DVD disc system including a large-capacity write-once-read-many optical disc for data such as large capacity write-once-read-many compact disc, DVD-R and DVD+R; and a large-capacity optical card. As a matter of course, the optical recording medium of the present invention can be applied to a CD-R medium.

Moreover, the addition and mixing of other metal chelate dyes such as azo dye, formazan dye and dipyrromethene dye according to requirements improves further the light resistance. Furthermore, by controlling the refractive index of the recording layer (monolayer) with respect to the recording and reproducing light and by employing a specific metal or an alloy thereof for the reflective layer, it is possible to provide an optical recording medium which enables a recording and reproducing with a stable, high reflectivity and high modulation.

Furthermore, the use of the optical recording medium of the present invention accomplishes an optical recording method and an optical recording apparatus which has no recording wavelength dependency at a recording wavelength of 600 nm to 720 nm and can perform a stable recording and reproducing even with repeated irradiation of light.

The present invention will be described below in more detail with reference to examples, but these examples are not to be construed as limiting the present invention. Also, squarylium metal chelate compounds which are used in the examples and comparative examples below were manufactured according to a method described in International Publication No. WO 2002/50190.

### EXAMPLE 1

A homogeneous solution (0.8% by mass) was prepared by mixing an aluminum chelate compound (A-11-A1) having a squarylium compound with a structural formula of A-11 in Table 2 as a ligand and a nickel chelate compound (A-11-Ni) having the same A-11 as a ligand at a mass ratio of 50 parts of A-11-A1 to 50 parts of A-11-Ni, and by dissolving this mixture in 2,2,3,3-tetrafluoropropanol.

The solution was then applied with a spinner on an injection-molded polycarbonate substrate having a thickness of 0.6 mm with a guide groove having a groove depth of 1,600 Å, a half bandwidth of 0.25 μm and a track pitch of 0.74 μm, and a recording layer of an organic dye layer having a thickness 1,000 Å was formed. Next, a reflective layer of silver having a thickness 1,200 Å was provided by the sputtering method, and a protective layer having a thickness of 5 μm was provided on the reflective layer by using an acrylic photopolymer. Furthermore, a 0.6-mm injection-molded polycarbonate substrate was laminated with an acrylic photopolymer, and an optical recording medium was prepared.

The remaining solution was left to stand at a room temperature for 14 days, and an optical recording medium was prepared in the same manner. The prepared optical recording media were evaluated under the conditions below.

That is, a recording with tracking was performed at a linear velocity of 3.5 m/sec on each optical recording medium with a semiconductor laser beam having an emission wavelength of 658 nm and a beam diameter of 1.0 μm. Then, a reproducing was performed with a continuous light of a semiconductor laser having an emission wavelength of 658 nm and a reproducing power of 0.7 mW. The reproducing waveform was observed, and the PI-Error was measured. Furthermore, a light resistance test and a storage test were performed under the following conditions. The results of the evaluations are shown in Table 4.

### <Test Conditions>

Light resistance test: continuous irradiation of a Xe light for 50 hours at an illuminance of 40,000 luxes;

Storage test: Left for 800 hours at a temperature of 50° C. and a relative humidity of 80%.

Furthermore, a part of the solution right after preparation was diluted 10-fold and used as a sample solution for liquid chromatography.

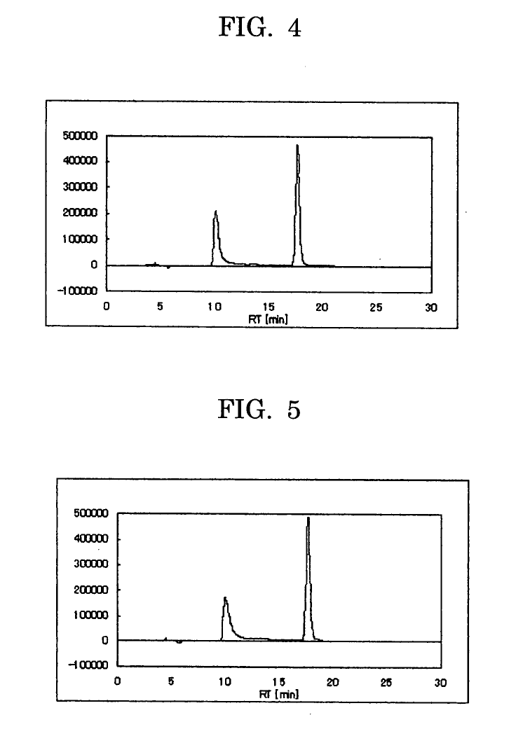

A liquid chromatography measurement using the obtained sample solution was performed under the conditions below. The measurement result is shown in FIG. 4. Also, this sample solution was left at a room temperature for 14 days, and a liquid chromatography measurement was performed in the same manner. The result is shown in FIG. 5.

### <Conditions for Liquid Chromatography>

Column: Inertsil ODS-2 (4.6 mm×250 mm), manufactured by GLScience, Inc.

Column temperature: 35° C.

Eluent of the eluting solution:
acetonitrile:ethyl acetate:water=55:25:20 (% by volume)

Flow rate: 0.5 mL/min

Detection: 254 nm

Sample injection volume: 5 μL

FIG. 5 shows that no new peak was observed in the squarylium metal chelate compound solution even after standing for 14 days, and this confirmed that there was no formation of isomer or other compounds and that there was no alteration in the ligand.

### COMPARATIVE EXAMPLE 1

A homogeneous solution (0.1% by mass) was prepared by mixing an aluminum chelate compound (A-10-Al) having a squarylium compound with a structural formula of A-10 in Table 2 as a ligand and an aluminum chelate compound (A-15-Al) having a squarylium compound with a structural formula of A-15 in Table 3 as a ligand at a mass ratio of 80 parts of A-10-Al to 20 parts of A-15-Al, and by dissolving this mixture in 2,2,3,3-tetrafluoropropanol. Optical recording media were prepared with this solution and evaluated in the same manner as Example 1. The results of the evaluations are shown in Table 4. Furthermore, a part of the solution right after preparation was diluted 10-fold and used as a sample solution for liquid chromatography.

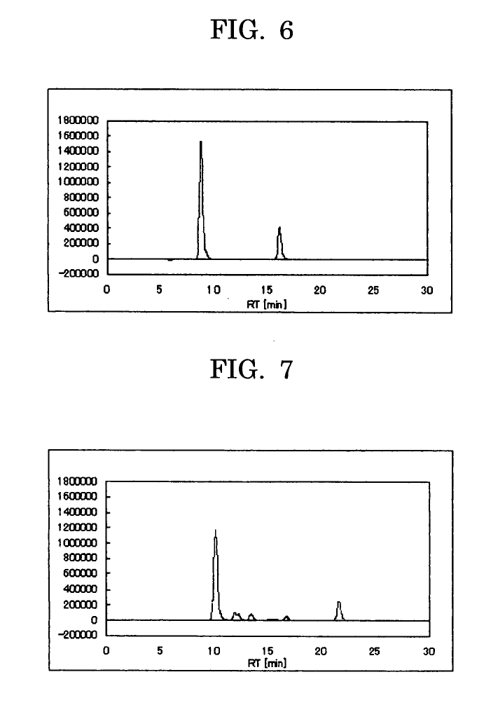

A liquid chromatography measurement using the obtained sample solution was performed under the same conditions as those in Example 1. The measurement results are shown in FIG. 6. Also, this sample solution was left at a room temperature for 14 days, and a liquid chromatography measurement was performed in the same manner. The results are shown in FIG. 7.

FIG. 7 shows that new peaks were detected, and this confirmed that a new compound is formed from the two different types of the aluminum chelate compounds.

### EXAMPLE 2

The aluminum chelate compound (A-11-Al) and the nickel chelate compound (A-11-Ni) used in Example 1 were mixed with a compound represented by General Formula (VIII) below, which hereinafter may also be referred to as Compound (VIII), at a mass ratio (A-11-Al):(A-11-Ni):(Compound (VIII)) of 30:30:40. Then, a solution was prepared by dissolving this mixture in 2,2,3,3-tetrafluoropropanol such that the solid concentration was 1% by mass. The solution was then applied with a spinner on an injection-molded polycarbonate substrate having a thickness of 0.6 mm with a guide groove having a groove depth of 1,600 Å, a half bandwidth of 0.25 μm and a track pitch of 0.74 μm, and a recording layer of an organic dye layer having a thickness 1,000 Å was formed. Next, a reflective layer of silver having a thickness 1,200 Å was provided by the sputtering method, and a protective layer having a thickness of 5 μm was provided on the reflective layer by using an acrylic photopolymer. Furthermore, a 0.6-mm injection-molded polycarbonate substrate was laminated with an acrylic photopolymer, and an optical recording medium was prepared.

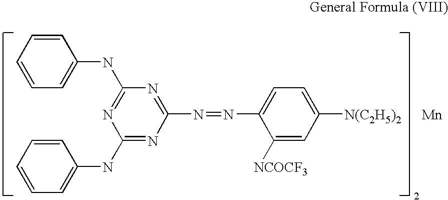

The prepared optical recording medium was evaluated under the following conditions.

A recording with tracking was performed at a linear velocity of 3.5 m/sec on the optical recording medium with a semiconductor laser beam having an emission wavelength of 658 nm and a beam diameter of 1.0 μm. Then, a reproducing was performed with a continuous light of a semiconductor laser having an emission wavelength of 658 nm and a reproducing power of 0.7 mW. The reproducing waveform was observed, and the PI-Error was measured. Furthermore, a light resistance test and a storage test were performed under the following conditions. The results of the evaluations are shown in Table 4.

### <Test Conditions>

Light resistance test: continuous irradiation of a Xe light for 50 hours at an illuminance of 40,000 luxes;

Storage test: Left for 800 hours at a temperature of 50° C. and a relative humidity of 80%.

### EXAMPLE 3

The dye inside a spin coater which had been scattered in the spin-coating process in Example 2 was recovered and dissolved in 2,2,3,3-tetrafluoropropanol. This solution was diluted ten-fold, and the concentration was determined by liquid chromatography under the same conditions as above. The concentrations of A-11-Al, A-11-Ni and Compound (VIII) were calculated to be 0.308%, 0.332% and 0.389%, respectively. The shortfalls were made up based on these results, and a dye solution was prepared once again such that the solid concentration was 1.0% and that the composition ratio (A-11-Al):(A-11-Ni):(Compound (VIII)) was 30:30:40. An optical recording medium was prepared with this solution in the same manner as Example 2. The prepared optical recording medium was tested for light resistance and storage in the same manner as Example 2. The results are similarly shown in Table 4 below.

### EXAMPLE 4

A recording medium was prepared exactly in the same manner as Example 2 except the squarylium metal chelate compounds used in Example 2 were replaced by an aluminum chelate compound with a structural formula of A-6 as a ligand in Table 1 (A-6-Al) and a copper chelate compound also having A-6 as a ligand (A-6-Cu), Compound (VIII) was replaced by a compound represented by General Formula (IX) below, which hereinafter may also be referred to as Compound (IX) and that mixing ratio by mass of the above compounds was changed to 40:20:40. The prepared optical recording medium was tested for light resistance and storage in the same manner as Example 2. The results are similarly shown in Table 4 below.

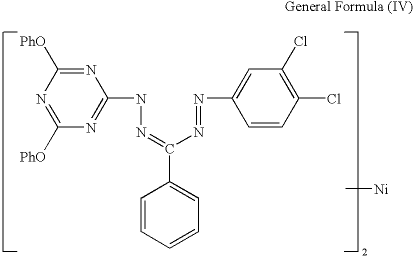

where, in General Formula (IV), Ph represents a phenyl group.

### EXAMPLE 5

The dye inside a spin coater which had been scattered in the spin-coating process in Example 4 was recovered and dissolved in 2,2,3,3-tetrafluoropropanol. This solution was diluted ten-fold, and the concentration was determined by liquid chromatography under the same conditions as above. The concentrations of A-6-Al, A-6-Cu, and Compound (IX) were calculated to be 0.411%, 0.212% and 0.385%. The shortfalls were made up based on these results, and a dye solution was prepared once again such that the solid concentration was 1.0% and that the composition ratio (A-6-Al):(A-6-Cu):(IX) was 40:20:40. An optical recording medium was prepared with this solution in the same manner as Example 4. The prepared optical recording medium was tested for light resistance and storage in the same manner as Example 4. The results are similarly shown in Table 4 below.

TABLE 4

| | | | | After Light | | After | |
|---|---|---|---|---|---|---|---|
| | | Initial Value | | Resistance Test | | Storage Test | |
| | | Reflec- | | Reflec- | | Reflec- | |
| | | tivity | PI- | tivity | PI- | tivity | PI- |
| Example | | (%) | Error | (%) | Error | (%) | Error |
| Example 1 | Right | 62 | 8 | 50 | 38 | 47 | 50 |
| | After | | | | | | |
| | Prepa- | | | | | | |
| | ration | | | | | | |
| | After | 61 | 9 | 50 | 42 | 48 | 53 |
| | 14 | | | | | | |
| | days | | | | | | |
| Comparative | After | 68 | 11 | 44 | 150 | 44 | 250 |
| Example 1 | Prepa- | | | | | | |
| | ration | | | | | | |
| | After | 60 | 35 | 38 | 288 | 37 | 355 |
| | 14 | | | | | | |
| | days | | | | | | |

| | | | | | | |
|---|---|---|---|---|---|---|
| Example 2 | 54 | 3 | 54 | 13 | 53 | 23 |
| Example 3 | 54 | 4 | 53 | 18 | 53 | 22 |
| Example 4 | 48 | 6 | 49 | 17 | 48 | 23 |
| Example 5 | 49 | 6 | 48 | 20 | 47 | 30 |

The results in Table 4 indicate that the use of a common ligand for a plurality of squarylium metal chelate compounds as in the optical recording medium of the present invention causes no change due to ligand scrambling in the chelates even after leaving in an organic solvent and that PI-Error and the variation in the reflectivity are small even after the light resistance test and the storage test. Moreover, the results also indicate that, by the reuse of the scattered dye after spin-coating (solution of squarylium metal chelate compounds) after it is recovered and the concentration is determined by liquid chromatography, it is possible to obtain the properties equivalent to those before the recovery.

Production examples of the squarylium metal chelate compounds shown in Table 3 as A-8-Ni, A-8-Cu and A-8-Zn are described in Production Examples 1 to 3. Other squarylium metal chelate compounds listed in Tables 1 to 3 were synthesized similarly to these Production Examples.

### PRODUCTION EXAMPLE 1

### Manufacturing of A-8-Ni

To a mixture of 1.50 g of a compound represented by General Formula (X) below and 0.36 g of nickel acetate tetrahydrate, 10.5 mL of ethyl acetate, 4.5 mL of methanol and 0.01 g of acetic acid were added. The mixture was then reacted at a temperature of 60° C. for three hours. The precipitate of the reaction was filtered, and 1.45 g of a squarylium metal chelate compound (Compound A-8-Ni) was obtained. The result of mass spectrometry of Compound A-8-Ni was MS (M-)m/z: 1166, and it was confirmed that the obtained compound was the intended compound.

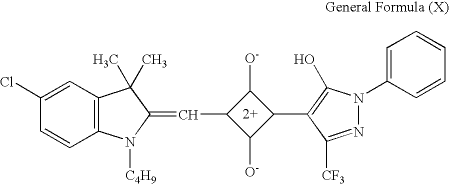

### PRODUCTION EXAMPLE 2

### Manufacturing of A-8-Cu

To a mixture of 1.50 g of the compound represented by General Formula (X) above and 0.27 g of copper sulfate monohydrate, 7.5 mL of ethyl acetate, 7.5 mL of methanol and 0.01 g of acetic acid were added. The mixture was then reacted at a temperature of 60° C. for five hours. The precipitate of the reaction was filtered, and 1.39 g of a squarylium metal chelate compound (Compound A-8-Cu) was obtained. The result of mass spectrometry of Compound A-8-Cu was MS (M-)m/z: 1173, and it was confirmed that the obtained compound was the intended compound.

### PRODUCTION EXAMPLE 3

### Manufacturing of A-8-Zn

To a mixture of 1.00 g of the compound represented by General Formula (X) mentioned above, 0.19 g of zinc acetylacetonate, 12.0 mL of ethyl acetate and 0.05 g of acetic acid were added. The mixture was then reacted at a temperature of 60° C. for two hours. The precipitate of the reaction was filtered, and 0.95 g of a squarylium metal chelate compound (Compound A-8-Zn) was obtained. The result of mass spectrometry of Compound A-8-Zn was MS (M-)m/z: 1172, and it was confirmed that the obtained compound was the intended compound.

### EXAMPLE 6

The squarylium metal chelate compounds A-11-Ni in Table 2 and A-16-Al in Table 3 were mixed with a compound represented by General Formula (XI) below, which hereinafter may also be referred to as Compound (XI), at a mass ratio (A-11-Ni):(A-16-Al):(XI) of 30:30:40. Then, a solution was prepared by dissolving this mixture in 2,2,3,3-tetrafluoropropanol such that the solid concentration was 1% by mass. An optical recording medium was prepared with the solution and evaluated in the same manner as in Example 2. The results are shown in Table 5. The solution was then applied with a spinner on an injection-molded polycarbonate substrate having a thickness of 0.6 mm with a guide groove having a groove depth of 1,600 Å, a half bandwidth of 0.25 μm and a track pitch of 0.74 μm, and a recording layer of an organic dye layer having a thickness 1,000 Å was formed.

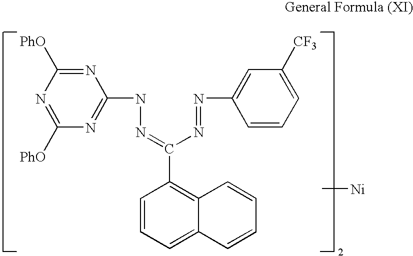

where, in General Formula (XI), Ph represents a phenyl group.

The prepared optical recording medium was evaluated under the following conditions.

A recording with tracking was performed at a linear velocity of 3.5 m/sec on the optical recording medium with a semiconductor laser beam having an emission wavelength of 658 nm and a beam diameter of 1.0 μm. Then, a reproducing was performed with a continuous light of a semiconductor laser having an emission wavelength of 658 nm and a reproducing power of 0.7 mW. The reproducing waveform was observed, and the PI-Error was measured. Furthermore, a light resistance test and a storage test were performed under the following conditions. The results of the evaluations are shown in Table 5.

### <Test Conditions>

Light resistance test: continuous irradiation of a Xe light for 50 hours at an illuminance of 40,000 luxes;

Storage test: Left for 800 hours at a temperature of 50° C. and a relative humidity of 80%.

### EXAMPLE 7

An optical recording medium was prepared exactly in the same manner as Example 6 except the squarylium metal chelate compound used in Example 2 was by two types thereof, namely A-2-Zn in Table 1 and A-16-Al in Table 3, the compound represented by General Formula (XI) was replaced by a compound represented by General Formula (XII) below, the mixing ratio by mass of (A-2-Zn):(A-16-Al):(XII) was changed to 40:40:20, silver in the reflective layer was replaced by gold, and that the thickness of the reflective layer was changed to 1,300 Å. The prepared optical recording medium was tested in the same manner as Example 6. The results are similarly shown in Table 5 below.

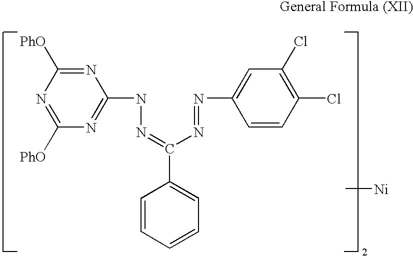

where, in General Formula (XII), Ph represents a phenyl group.

### EXAMPLE 8

An optical recording medium was prepared exactly in the same manner as Example 7 except the squarylium metal chelate compounds used in Example 7 were replaced by two types thereof, namely A-10-Cu in Table 2 and A-8-Al in Table 2, the compound represented by General Formula (XII) was replaced by a compound represented by General Formula (XIII), and that the mixing ratio by mass of (A-10-Cu):(A-8-Al):(XIII) was changed to 20:40:40.

The prepared optical recording medium was tested in the same manner as Example 6. The results are similarly shown in Table 5 below.

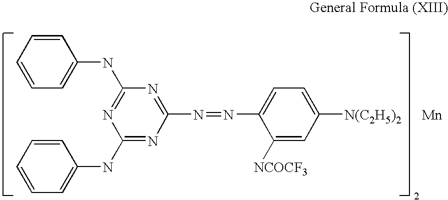

### EXAMPLE 9

An optical recording medium was prepared exactly in the same manner as Example 8 except that the squarylium metal chelate compounds used in Example 8 was replaced by two types thereof, namely A-8-Ni in Table 2 and A-16-Al in Table 3, and that the mixing ratio by mass (A-8-Ni):(A-16-Al):(XIII) was changed to 15:50:25.

The prepared optical recording medium was tested for light resistance and storage in the same manner as Example 6. The results are similarly shown in Table 5 below.

### COMPARATIVE EXAMPLE 2

An optical recording medium was prepared exactly in the same manner as Example 6 except that only A-11-Ni was used as a squarylium metal chelate compound instead of the mixture of A-11-Ni and A-16-Al in Example 6 and the mixing ratio by mass (A-11-Ni):(XI) was changed to 60:40.

The prepared optical recording medium was tested in the same manner as Example 6. The results are similarly shown in Table 5 below.

### COMPARATIVE EXAMPLE 3

An optical recording medium was prepared exactly in the same manner as Example 7 except that only A-2-Zn was used as a squarylium metal chelate compounds instead of A-2-Zn and A-16-Al and that the mixing ratio by mass (A-2-Zn):(XII) was changed to 80:20. The prepared optical recording medium was tested in the same manner as Example 6. The results are similarly shown in Table 5 below.

### COMPARATIVE EXAMPLE 4

An optical recording medium was prepared in the same manner as Example 8 except that only A-10-Cu was used as a squarylium metal chelate compound instead of A-10-Cu and A-8-Al in Example 8 and that the mixing ratio by mass (A-10-Cu):(XIII) was changed to 60:40.

The prepared optical recording medium was tested in the same manner as Example 6. The results are similarly shown in Table 5 below.

### COMPARATIVE EXAMPLE 5

An optical recording medium was prepared in the same manner as Example 7 except that only A-16-Al was used as a squarylium metal chelate compound without using A-2-Zn.

The prepared optical recording medium was tested in the same manner as Example 6. The results are similarly shown in Table 5 below.

### COMPARATIVE EXAMPLE 6

An optical recording medium was prepared in the same manner as Example 7 except that a squarylium compound which is not a metal complex in General Formula (X) in Manufacturing Example 1 was used instead of the squarylium metal chelate compounds in Example 7.

The prepared optical recording medium was tested in the same manner as Example 6. The results are similarly shown in Table 5 below.

TABLE 5

| | | | After Light | | After | |
|---|---|---|---|---|---|---|
| | Initial value | | Resistance Test | | Storage Test | |
| | Reflec- | | Reflec- | | Reflec- | |
| | tivity | Pi- | tivity | PI- | tivity | PI- |
| Example | (%) | Error | (%) | Error | (%) | Error |
| Example 6 | 49 | 1 | 48 | 10 | 47 | 18 |
| Example 7 | 54 | 3 | 52 | 20 | 51 | 25 |
| Example 8 | 48 | 5 | 49 | 13 | 48 | 20 |
| Example 9 | 49 | 4 | 49 | 17 | 50 | 27 |
| Comparative | 38 | 25 | 37 | 33 | 38 | 44 |
| Example 2 | | | | | | |
| Comparative | 43 | 15 | 41 | 35 | 41 | 46 |
| Example 3 | | | | | | |
| Comparative | 33 | 35 | 34 | 43 | 33 | 51 |
| Example 4 | | | | | | |
| Comparative | 54 | 3 | 46 | 98 | 46 | 114 |
| Example 5 | | | | | | |
| Comparative | 58 | 2 | 45 | 153 | 45 | 164 |
| Example 5 | | | | | | |

The results in Table 5 indicate that the use of a squarylium metal chelate compound having a bivalent metal as its central metal and a squarylium metal chelate compound having a metal other than a bivalent metal as its central metal in the recording layer (Examples 6 to 9) reduces the PI-Error and the variation in the reflectivity even after the light resistance test and the storage test and improves the light resistance while maintaining the optical characteristics, compared to cases where only one type of a squarylium metal chelate compound is included in the recording layer (Comparative Examples 2 to 5) and a squarylium compound which is not a metal complex is included alone in the recording layer (Comparative Example 6).

### INDUSTRIAL APPLICABILITY

An optical recording medium of the present invention is favorably applied in particular to a write-once-read-many DVD disc system since it improves the light resistance as well as controls the optical characteristics precisely compared to a conventional optical recording medium having a squarylium compound and an aluminum chelate compound thereof.

1. An optical recording medium comprising:
a substrate, and
a recording layer on the substrate comprising squarylium metal chelate compounds,
wherein the recording layer comprises a mixture comprised of squarylium metal chelate compounds having two or more different metals.

2. The optical recording medium according to claim 1,
wherein the recording layer comprises a squarylium metal chelate compound having a bivalent metal as its metal, and a squarylium metal chelate compound having a metal other than a bivalent metal as its metal.

3. The optical recording medium according to claim 1,
wherein the squarylium metal chelate compounds comprise the same ligand.

4. The optical recording medium according to claims 1,
wherein the squarylium metal chelate compounds are represented by General Formula (I) below: 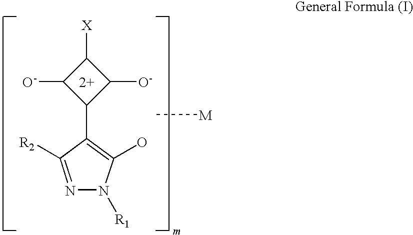
wherein, in General Formula (I), R₁ and R₂ are the same or different and represent a hydrogen atom, an aliphatic group which may have a substituent, an aralkyl group which may have a substituent, an aryl group which may have a substituent or a heterocyclic group which may have a substituent;
M represents a metal atom which has a coordinating property;
m represents an integer of two or three; and
X represents an aryl group which may have a substituent, a heterocyclic group which may have a substituent or [Z₁=CH—],
wherein Z₁ represents a heterocyclic group which may have a substituent.

5. The optical recording medium according to claim 4,
wherein X in General Formula (I) is represented by General Formula (II) below: 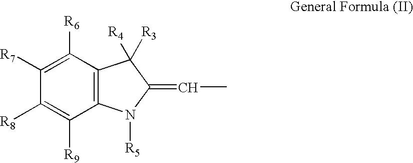
wherein, in General Formula (II), R₃ and R₄ are the same or different and represent an aliphatic group which may have a substituent or are taken together with an adjacent carbon atom to form an alicyclic hydrocarbon ring which may have a substituent or a heterocyclic ring which may have a substituent;
R₅ represents a hydrogen atom, an aliphatic group which may have a substituent, an aralkyl group which may have a substituent or an aryl group which may have a substituent;
R₆ to R₉ may be the same or different and represent a hydrogen atom, a halogen atom, an aliphatic group which may have a substituent, an aralkyl group which may have a substituent, an aryl group which may have a substituent, a nitro group, a cyano group, or an alkoxyl group which may have a substituent; and
two mutually adjacent functional groups among R₆ to R₉ may combine with two respective adjacent carbon atoms to form a ring which may have a substituent.

6. The optical recording medium according to claim 1
wherein the central metal is a metal selected from aluminum, nickel, copper, and zinc.

7. The optical recording medium according to claim 1,
wherein the bivalent metal is at least any one metal selected from nickel, copper, and zinc.

8. The optical recording medium according to claims 2,
wherein the squarylium metal chelate compound having a metal other than the bivalent metal as its central metal is a trivalent aluminum chelate compound.

9. The optical recording medium according to claim 1,
wherein the recording layer further comprises at least one type of metal chelate dye selected from an azo metal chelate dye, a formazan metal chelate dye, and a dipyrromethene metal chelate dye.

10. The optical recording medium according to claim 9,
wherein the central metal of the metal chelate dye is at least one metal selected from nickel, copper, cobalt, manganese, and vanadium oxide.

11. The optical recording medium according to claim 1,
wherein the recording layer as a monolayer has a refractive index n of 1.5≦n≦3.0 and an extinction coefficient k of 0.02≦k≦0.3 with respect to a light having a wavelength of the recording and reproducing wavelength ±5 nm.

12. The optical recording medium according to claim 1
wherein the recording medium comprises a reflective layer; and
the reflective layer is any one of gold, silver, copper, aluminum, and an alloy of these metals.

13. The optical recording medium according to claim 1,
wherein the optical recording medium has a track pitch on the substrate of 0.7 μm to 0.8 μm and a groove width of 0.18 μm to 0.40 μm.

14. The optical recording medium according to claim 1,
wherein the recording is possible at a recording wavelength of 600 nm to 720 nm.

15. An optical recording method comprising the step of recording at a wavelength of 600 nm to 720 nm in the optical recording medium,
wherein the optical recording medium comprises:
a substrate, and
a recording layer on the substrate comprising squarylium metal chelate compounds,
wherein the recording layer comprises a mixture comprised of squarylium metal chelate compounds having two or more different metals.

16. An optical recording apparatus comprising a recording medium therein,
wherein the optical recording apparatus performs a recording and reproducing by irradiating a light to the recording medium; and
the optical recording medium comprises:
a substrate, and
a recording layer on the substrate comprising squarylium metal chelate compounds,
wherein the recording layer comprises a mixture comprised of squarylium metal chelate compounds having two or more different metals.
